(19) United States
(12) Patent Application Publication
(10) Pub. No.: US 2010/0324970 A1
(43) Pub. Date: Dec. 23, 2010

(54) System and Method For Intelligent Job Hunt

(76) Inventors: Promise Phelon, San Jose, CA (US); Suraj Prakash Dasika, Santa Clara, CA (US); Lisa Ann Strand, Los Gatos, CA (US); Sarah A. Lynn, Fairfield, CA (US); Robin Wei-Ting Chang, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/505,447

(22) Filed: Jul. 17, 2009

Related U.S. Application Data
(60) Provisional application No. 61/219,608, filed on Jun. 23, 2009.

(51) Int. Cl. G06Q 10/00; G06N 5/02; G06Q 50/00; G06F 17/30

(52) U.S. Cl. 705/10; 706/52; 705/7; 707/759; 707/769; 707/912; 707/955; 707/713; 707/812

(57) ABSTRACT

A system, computer readable storage medium, and computer-implemented method performs an intelligent job hunt to determine a sorted set of job openings relevant to a user's career goals. An intelligent job hunt engine uses user profile information to query a job openings index for job's relevant to the user. Results of the query are filtered and sorted according to their relevance to different career goals. A job readiness evaluator determines readiness scores indicative of the user's preparedness for reaching a career goal. Specific action items are generated based on the user's interaction with the sorted job openings and the user's job readiness scores.

### RELATED APPLICATIONS

This application claims priority from U.S. provisional application No. 61/219,608 filed on Jun. 23, 2009 and entitled “Intelligent Job Hunt,” which is incorporated by reference herein in its entirety.

### BACKGROUND

1. Field of the Art

The invention relates generally to job searching, and more specifically to performing an intelligent job hunt based on a user profile.

2. Background

Finding a job can be a difficult and time-consuming task. Career websites or job boards allow recruiters to post job listings that can be searched by job seekers using text-based queries. However, using such websites to search for a job can be overwhelming because such websites may list thousands of job openings at any given time. Of the large number of job openings, only a small percentage will likely be relevant to a particular individual's career goals. Furthermore, the list of job openings may not be presented in a manner that allows the individual to efficiently navigate the results and determine which job listings are most relevant. Moreover, conventional job hunting websites fail to provide any guidance to assist an individual in obtaining a job that actually matches the individual's career goals. Therefore, an improved system and method for job hunting is needed.

### SUMMARY OF THE INVENTION

A system, computer readable storage medium, and computer-implemented method sorts a set of job openings according to their relevance to a user. An intelligent job hunt (IJH) engine receives profile information related to a user's career goals. The IJH engine determines target job criteria for the user based on the profile information. The IJH engine also determines a set of current job openings. The IJH engine computes a first matching score between a job opening and first target job criteria, and computes a second matching score between the job opening and the second target job criteria. Optionally, the IJH engine computes additional matching scores for the job opening and additional target job criteria. The matching scores are weighted and combined to generate an overall matching score for the job opening. The IJH engine sorts the set of job openings according to their overall scores and outputs the sorted list.

Beneficially, the disclosed embodiments provide a intelligent job hunting system that provides job information to the user specific to the user's career goals. The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram illustrating an intelligent job hunting (IJH) system in accordance with an embodiment of the present invention.

FIG. 2 is a block diagram illustrating an IJH engine in accordance with an embodiment of the present invention.

FIG. 3 is a flowchart illustrating a process performed by the IJH engine for an intelligent job hunt in accordance with an embodiment of the present invention.

FIG. 4 is a flowchart illustrating a process for matching a job opening to an entry in a standardized job description index in accordance with an embodiment of the present invention.

FIG. 5 is a flowchart illustrating a process for sorting job openings using a category filter in accordance with an embodiment of the present invention.

FIG. 6 is a flowchart illustrating a process for analyzing user interactions and providing dynamic updates in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

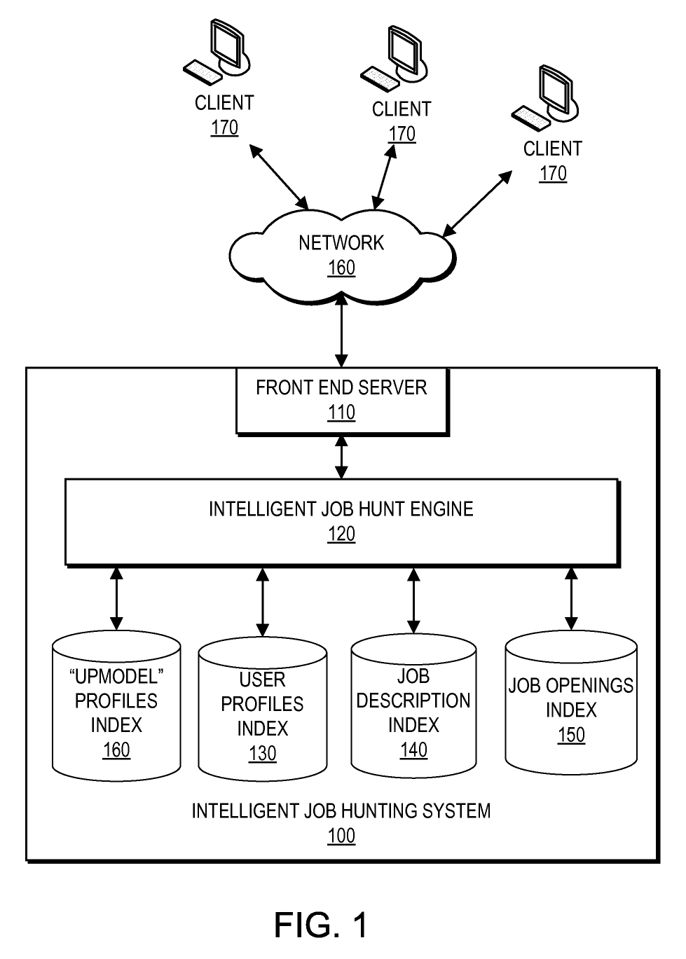

FIG. 1 illustrates an embodiment of a intelligent job hunting (IJH) system 100. The IJH system 100 finds and presents a set of job openings to a user based on the user's specific career goals, interests, and abilities. The IJH system 100 furthermore presents to the job openings to the user in a manner that allows the user to easily determine the jobs he/she is most interested in. Furthermore, the IJH system 100 determines a set of action items specific to the user to assist the user in reaching his/her specific career aspirations.

In one embodiment, the IJH system 100 comprises a computer-implemented expert that provides probable job matches for its users. The IJH system 100 collects a variety of information about the user, including employment history, skills, geographic location, people the user knows, activities the user participates in, short and long-term desires, and impressions of the user by others. The IJH system 100 collects this information directly from the user, from the user's peer group, and from the user's behavior within the system. Information about the user can also be collected through web sources outside of the system, including, for example, profiles of the user on other sites or secondary information about the user. Information about the user is synthesized with internal and external data sets to provide highly-probable job matches tailored towards that user.

In one embodiment, the intelligent job hunting system 100 comprises a front end server 110, an IJH engine 120, a user profile index 130, an “UpModel” profile index 160, a job description index 140, and a job openings index 150. Those of skill in the art will recognize that other embodiments can have different modules than the ones described here, and that the functionalities can be distributed among the modules in a different manner. In addition, the functions ascribed to the various modules can be performed by multiple engines.

Each of the various components (alternatively, modules) e.g., front end server 110, IJH engine 120, user profiles index 130, job description index 140, and job openings index 150, is implemented as part of a computer system with one or more computers comprising a CPU, memory, network interface, peripheral interfaces, and other well known components. The computers themselves preferably run an operating system (e.g., LINUX), have CPUs, memory, and disk storage.

In this embodiment, the modules are stored on a computer readable storage device (e.g., hard disk), loaded into the memory, and executed by one or more processors included as part of the system 100. Alternatively, hardware or software modules may be stored elsewhere within the system 100. When configured to execute the various operations described herein, a general purpose computer becomes a particular computer, as understood by those of skill in the art, as the particular functions and data being stored by such a computer configure it in a manner different from its native capabilities as may be provided by its underlying operating system and hardware logic. It will be understood that the named components of the IJH system 100 described herein represent one embodiment of the present invention, and other embodiments may include other components. In addition, other embodiments may lack components described herein and/or distribute the described functionality among the modules in a different manner. Additionally, the functionalities attributed to more than one component can be incorporated into a single component.

FIG. 1 also illustrates three client devices 170 communicatively coupled to the IJH system 100 over a network 160. The client devices 170 can be any type of communication device that is capable of supporting a communications interface to the system 100. Suitable devices may include, but are not limited to, personal computers, mobile computers (e.g., notebook computers), personal digital assistants (PDAs), smartphones, mobile phones, and gaming consoles and devices, network-enabled viewing devices (e.g., settop boxes, televisions, and receivers). Only three clients 170 are shown in FIG. 1 in order to simplify and clarify the description. In practice, thousands or millions of clients 170 can connect to the IJH system 100 via the network 160.

The network 160 may be a wired or wireless network. Examples of the network 160 include the Internet, an intranet, a WiFi network, a WiMAX network, a mobile telephone network, or a combination thereof. The method of communication between the client devices 170 and the system 100 is not limited to any particular user interface or network protocol, but in a typical embodiment a user interacts with the IJH system 100 via a conventional web browser of the client device 170, which employs standard Internet protocols.

The clients 170 interact with the IJH system 100 via the front end server 110 to find and present the intelligent job hunting information to the user. The front end server 110 provides controls and elements that allow a user to provide inputs to the IJH system 100 for processing by the IJH engine 120 and for presenting information from the IJH engine 120 to the user. Typically, the front end server 110 presents the interface to the IJH system 100 in the form of a website including one or more web pages with which the user can interact via a conventional web browser.

The user profiles index 130 comprises an index of profiles associated with different users of the IJH system 100. Each profile includes information related to the user, and particularly, related to the user's career goals. Examples of information stored in a user profile can include a user's name, current job, jobs of interest, current location, locations of interest, previously viewed job openings, previously applied for jobs, specific career goals, employment history, skills, people the user knows, activities the user participates in, short and long-term desires, impressions about the user from others, etc.

In one embodiment, the user's profile also associates the user with a profile of one or more “role models” stored in an “UpModel” profiles index 160. A role model is someone who has achieved the user's career goals, or is on a career path similar to that desired by the user. The role model may be, for example, a real-life person, a fictional person, or a composite of various people. The “UpModel” profile index 160 stores profile information related to the role models such as, for example, the role model's name, educational background, career path, accomplishments, skills, activities, reputation, personality, companies worked for, places of residence, etc. A more detailed description of system and method for associating a role model with a user is described in U.S. patent application Ser. No. 12/330,312 entitled “Determining a Target Career Path and Tasks to Achieve the Same,” filed on Dec. 8, 2008, the contents of which are hereby incorporated by reference in its entirety.

In one embodiment, the user's profile also includes a list of other individuals that are linked to the user through a social network. User's can link to each other within the IJH system 100 to reflect a relationship through friendship, employer, professional area, schools attended, home location, or any other criteria linking the users together. Additionally, a user's profile can indicate social network relationships on external social networking sites such as, for example, facebook.com, myspace.com, linkedin.com, etc.

The job description index 140 comprises a standardized index of job descriptions. Each entry of the job description index 140 comprises a set of fields describing a particular job such as a job title, a job description, a job level, salary statistics, experience required, skills required, and so on. A job title in the job description index 140 may explicitly include the job level within the title. For example, an entry level engineering job may be represented by a job title “Engineer I”, while an experienced engineering job may be represented by a job title “Engineer V”. An entry in the job description index 140 may include both a primary job title, and a set of alternative job titles that each map to the primary job title. For example, a standard job title “Reporter II”, may have alternative job titles “Intermediate Level Report” or “Columnist II.” Each entry also typically includes a job description field. This field includes a text-based description of the typical responsibilities and skills required for someone holding the job title. Other fields such as salary statistics, experience required, hours/week, etc. provide additional information about the job title. An example of a standardized job description index 140 is the job index provided by Salary.com.

The job openings index 150 comprises an index of current job openings listed on various career websites or job boards. For example, the job openings index 150 can include job openings listed on websites such as Simplyhired.com, Monster.com, Craigslist.com, Indeed.com, Careerbuilder.com, and so on. Additionally, the job openings index 150 can include job listings from corporate intranets and extranets, government databases, networking website such as Twitter.com, Facebook.com, Myspace.com, etc., or jobs directly uploaded to the IJH system 100 by recruiters.

Generally, the entries in the job openings index 150 have multiple fields that are filled in by recruiters when the job openings are posted. Examples of fields can include job title, job description, salary range, experience required, hours/week, skills required, and so on. The entries in the job openings index 150 do not necessarily conform to any particular standard. Rather the fields for each entry in the job openings index 150 contain text as entered by a recruiter. Thus, titles and descriptions of the job openings in the job openings index 150 do not necessarily conform to the standardized set of titles and descriptions in the job description index 140.

Although the various indices (i.e. user profiles index 130, job description index 140, and job openings index 150) are illustrated as part of the IJH system 100 for the sake of clarity and convenience, all or part of the indices 130, 140, 150 can include data stored remotely from each other or remotely from other components of the IJH system 100. For example, all or part of the job description index 140 can be stored on an external server (e.g., the Salary.com server) that is remote from the server running the IJH engine 120 and front end server 110. Similarly, all or parts of the job openings index can be stored on servers maintained by various job boards (e.g., simlyhired.com, monster.com, craigslist.org, etc.) remote from the IJH engine 120 and front end server 110. In one embodiment, remote indices are accessible by the IJH engine 120 via an Application Program Interface (API) via the network 160.

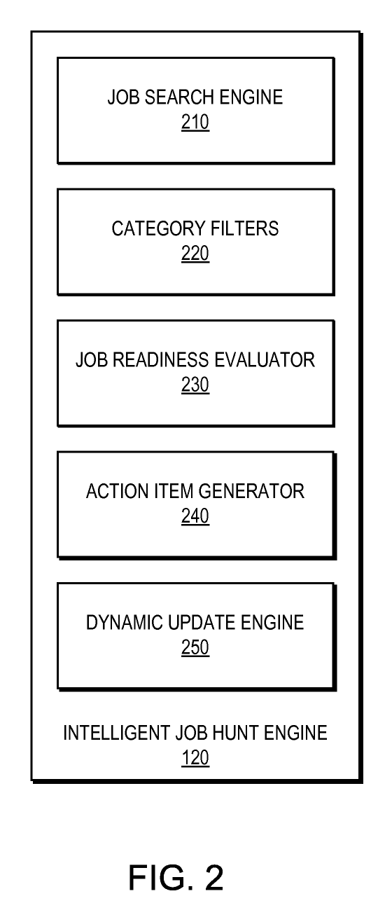

When a user logs into the IJH system 100, the IJH engine 120 retrieves a profile for the user from the user profiles index 130. Alternatively, if the user does not have a profile stored, the IJH engine 120 may prompt the user to create a profile, or allow the user to continue as a guest. Using information in the profile, the IJH engine 120 performs an intelligent job hunt to find job openings in the job openings index 150 that are relevant to the user. FIG. 2 illustrates a more detailed view of the intelligent job hunt engine 120. In one embodiment, the intelligent job hunt engine 120 comprises a job search engine 210, category filters 220, a job readiness evaluator 230, an action item generator 240, and a dynamic update engine 250. Those of skill in the art will recognize that other embodiments can have different modules than the ones described here, and that the functionalities can be distributed among the modules in a different manner. In addition, the functions ascribed to the various modules can be performed by multiple engines.

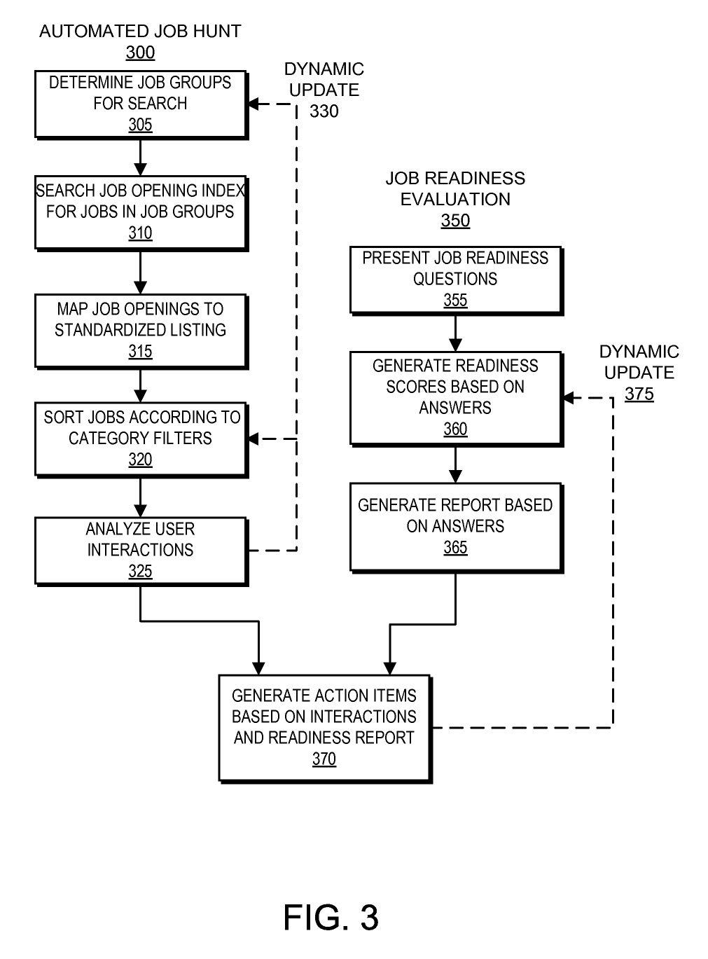

The job search engine 210 automates a search of the job openings index 150 to return a set of job openings relevant to a particular user's career goals. The retrieved set of job openings are filtered and sorted according to one or more category filters 220 to present the information in a manner useful to the user. An example of a process performed by the automated search engine 210 and the category filters 220 is illustrated in the automated job hunt path 300 of FIG. 3 described in more detail below.

The job readiness evaluator 230 determines one or more readiness scores indicative of the user's readiness for embarking on a job hunt, or for reaching a particular career goal. An example of a process performed by the job readiness evaluator 230 is illustrated in the job readiness evaluator path 350 of FIG. 3 and described in more detail below. The action item generator 240 generates a set of specific action items that the user should perform to reach his/her particular goals, based on the outputs of the job readiness evaluator 230, the automated job search engine 210, and the category filters 220 as will be described in more detail below with reference to FIG. 3. The dynamic update engine 250 analyzes various user interactions and dynamically updates the sorted lists of job openings and/or the job readiness scores based on the user interactions, as will be described in more detail below with reference to FIG. 3.

### Operation and Use

FIG. 3 illustrates an example embodiment of a process performed by the IJH engine 120. In the “automated job hunt” path 300 of FIG. 3, the job search engine 210 uses category filters 220 to perform an automated job hunt to present job openings to a user that are relevant to the user's particular career goals. In the “job readiness evaluation” path 350 of FIG. 3, the job readiness evaluator 230 presents job readiness questions to a user and generates a readiness report specific to the user and indicative of the user's preparedness for taking the next step in reaching his/her career goals.

Referring first to the “automated job hunt” path 300 of FIG. 3, the job search engine 210 initially selects 305 a set of job groups for searching. Each job group represents a set of related jobs. For example, jobs such as Biologist, Chemist, Physicist, etc. may all be classified together in a “Research and Science” job group. The categorization of specific jobs into job groups may be based on any job classification system. An example of a job classification system is the O*NET-SOC (or O*NET) job classification system. Thus, in one embodiment, the set of job groups for searching is represented by a set of O*NET-SOC codes, with each O*NET-SOC code corresponding to a different job group. Alternative embodiments can use other job classification systems that group jobs together differently than the O*NET-SOC job groupings, or use different codes to represent each job group.

The job search engine 210 determines 305 the set of job groups for searching based on information provided in the user's profile. For example, the user's profile may contain the user's current job and/or jobs that the user is interested in. Thus, the job groups for searching may include the job group of the user's current job, the job group for any jobs of interest to the user, the job group for a job the user has applied for or interviewed for in the past, etc. In one embodiment, the job groups for searching can also be selected based on jobs held by a role model from the “UpModel” profiles index 160 associated with the user's profile. For example, if the role model spent many years as a “Chemist”, the job search engine 210 may select the “Research and Sciences” job group as one of the groups for searching. The output of step 305 is a pool of job groups selected for searching based on information in the user's profile.

The job search engine 210 then searches 310 the job openings index 150 for jobs in the job groups selected in the previous step 305. The job search engine 210 queries the job openings index 150 using, for example, a textual query for the job group (e.g., “Research and Science”). Alternatively, the job search engine 210 can query using codes representative of the job groups (e.g., O*NET-SOC codes). In one embodiment, the query also limits the set of search results to job openings in a particular geographic area (e.g., within 50 miles of a specified zip code). The job search engine 210 can automatically determine one or more geographic areas of interest to the user based on information in the user's profile. For example, a geographic area of interest can be based on the user's home location, locations of interest defined by the user, locations where the user previously applied for jobs, locations that the user's role model worked or lived in, etc. The output of the searching step 310 is a pool of current job openings relevant to the user's profile and based on the specific job groups selected for searching.

The job search engine 210 maps 315 each job opening in the pool of retrieved job openings to an entry in the standardized job description index 140. As previously described, the information in the job openings index 150 does not necessarily conform to any particular standard, and instead simply contains information as a recruiter chose to enter it. By mapping 315 each relevant job opening to a standardized job description in the job description index 140, the IJH engine 120 can efficiently manipulate the data fields and present useful information to the user. For example, a recruiter may have declined to enter salary information for a particular job opening when posting the opening to the job openings index 150. However, by mapping the job opening to an entry in the standardized job description index 140, the IJH engine 120 can still determine typical salary information for the job opening and present that information to the user.

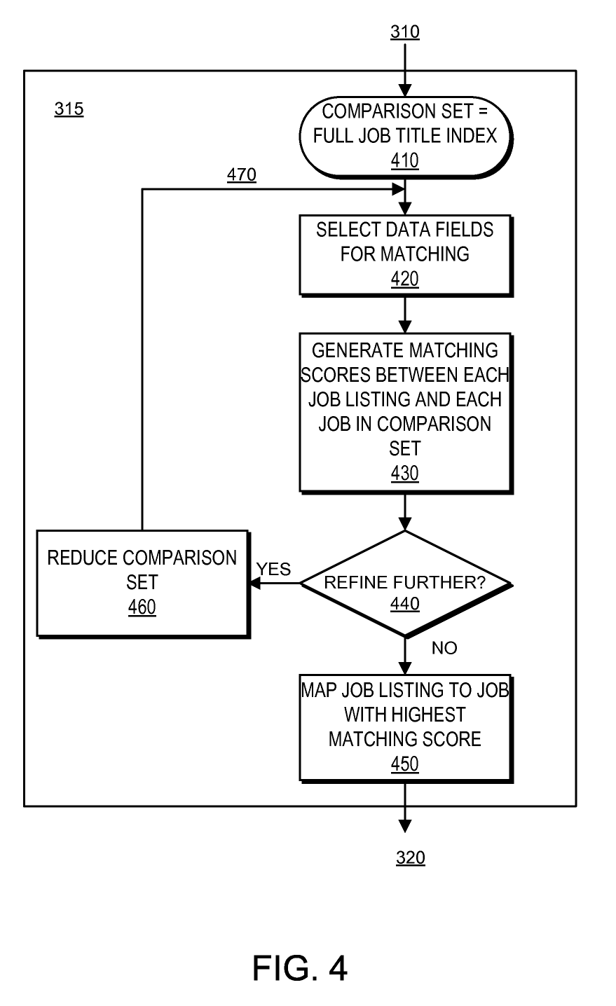

In one embodiment, the job search engine 210 maps 315 a job opening to an entry in the job description index 140 using a conventional pattern matching or word matching algorithm, such as, for example, a Boyer-Moore matching algorithm. The matching algorithm outputs a matching score representing the strength of the match between a particular job opening and an entry in the job description index 140. An example embodiment of a process for mapping a job opening to a standardized job description is described in more detail below with reference to FIG. 4. The output of the mapping step 315 is pool of jobs openings relevant to the user's profile, each of which is mapped to a particular standardized job description in the job description index 140.

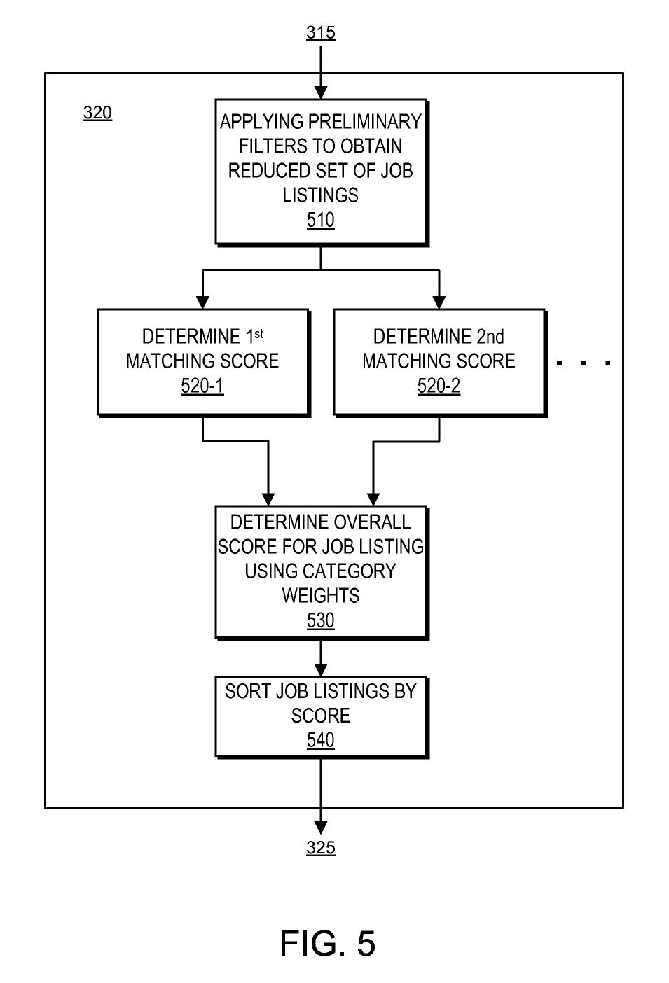

The job search engine 210 next sorts 320 the pool of jobs according to one or more category filters 220. A category filter 220 represents a particular way to filter and/or sort the jobs based on one or more goals. For example, an “In My Range” category filter 220 may be designed to filter/sort jobs to in a manner that gives greater weight to jobs that are similar to the user's current job. A “Near My Home” category filter 220 may be designed to filter/sort jobs in a manner that gives greater weight to jobs that are in proximity to the user's current residence. A “Boost My Ego” category filter 220 may filter/sort jobs to provide greater weight to jobs that are at least one job level higher than the user's current job. Other types of category filters 220 can filter and sort the job results according to different weighting criteria as will be apparent to those of ordinary skill in the art. An example embodiment, of a process for sorting 320 the jobs according to a category filter 220 is described in more detail below with reference to FIG. 5.

In one embodiment, the job search engine 210 determines one or more separate lists of job openings, each filtered and sorted according to a different category filter 220. In one embodiment, the user can select one or more category filters to apply from a set of predefined category filters 220. Alternatively, the user can create a customized category filter by specifying various weights to apply to different criteria in the sorting and filtering process. Examples of specific category filters 220 are described below with reference to FIG. 5.

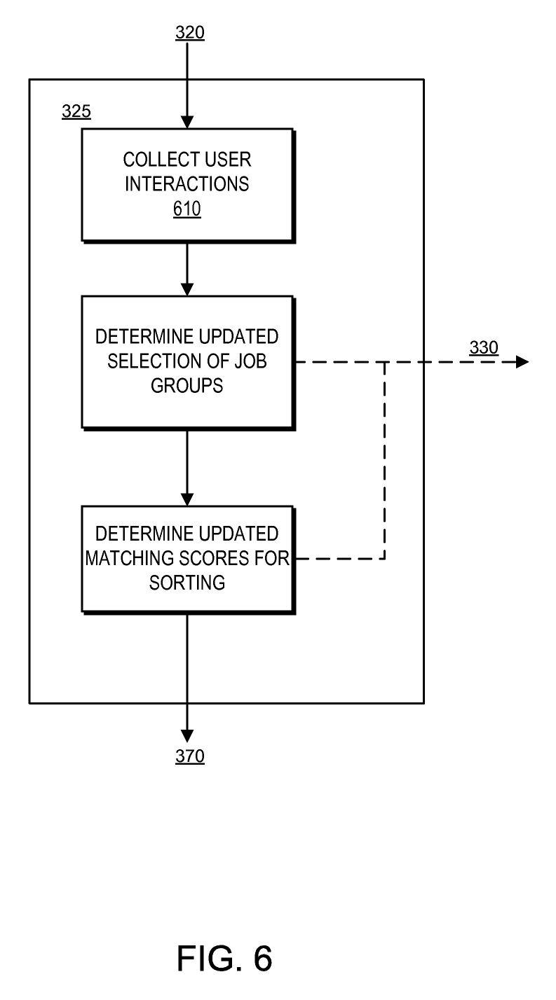

The dynamic update engine 250 analyzes 325 user interactions that are related to the sorted and filtered job openings. For example, the user can perform actions such as opening a particular job listing (e.g., to view more information about the job), marking a job listing (e.g., to express interest in the job listing and/or save the job listing for future viewing), deleting a job listing (e.g., to express disinterest in the job), and so on. Various user interactions with the job listings can be stored to the user's profile. The dynamic update engine 250 uses these stored interactions to learn more about the user and to improve the accuracy of future sorting and filtering processes. In one embodiment, the dynamic update engine 250 performs dynamic updates 330 based on the user interactions. For example, if a user marks a particular job opening, then that particular job opening or similar job openings may be given a higher weight in a subsequent sorting and filtering process. Additionally, if a user expresses interest in particular job openings, the job groups of those openings may be updated 330 to include the additional job groups in future searches. Furthermore, the dynamic updates 330 can be used to universally improve the mapping and sorting algorithms. For example, if a pattern of user interactions suggests that a particular job opening is not relevant to a particular job title or other attribute (e.g., because a large percentage of users having a similar job title delete the job opening), then the matching algorithm itself can be updated by using this information to improve future matching. An example process for analyzing 325 user interactions and providing dynamic updates 330 is described in more detail below with reference to FIG. 6.

Referring now to the “job readiness evaluation” path 350 of FIG. 3, the flowchart illustrates steps for acquiring information from a user to evaluate the user's readiness for embarking on a job hunt. In one embodiment, the job readiness evaluator 230 presents 355 job readiness questions to the user. The question may be presented 355 at the user's request (e.g., when the user selects a “job readiness” link on a website of the IJH system 100), or automatically when the user logs in to the system 100. In various embodiments, questions may be presented 355 simultaneously or in parallel. Furthermore, the questions presented 355 may be chosen based on information in the user's profile so that the questions are specific for the user. In some embodiments, questions include multiple choice answers in which the user selects a single answer from the list of answer choices. For example, the job readiness evaluator 230 may present the question “Which statement best describes how you feel about your job?,” followed by multiple choice answers such as “(A) I am happy with my job”; “(B) I would like a new job within the next year”; “(C) I am unemployed”; and so on. Other types of questions may allow the user to select multiple answers (e.g., “select all off the following that apply.”) Yet other types of questions may be entirely open-ended and allow the user to provide a text-based answer.

The job readiness evaluator 230 generates 360 one or more readiness scores based on the user's answers to the presented questions. In one embodiment, a set of scores are computed to rate the user in a variety of different categories. Categories can include, for example, Tools, Habit & Initiative, Network, Motivation, and so on. In one embodiment, each possible answer to the job readiness questions is assigned a number of points in a particular category. The totals points in each category are accumulated to provide the category scores.

The job readiness evaluator 230 generates 365 a report based on answers to the job readiness questions. In one embodiment, the report includes a display of the calculated scores in each category. Additionally, the report can include a comparison of the user's scores to average scores of other users. In some embodiments, the report includes text-based recommendations to the user that depend on the user's answers to the job readiness questions. For example, if the user indicates he/she does not have a resume prepared, the report might include text suggesting that the user prepare a resume. Additionally, the text may provide the user with helpful guidance and tips for preparing the resume.

The action item generator 240 generates 370 one or more action items based on the user's interactions with the presented list of job openings and based on the job readiness report. The action items give the user specific tasks that the user should perform in order to reach his/her career goals. For example, if the user marks a job in the list of job openings, an action items may be generated for the user to apply for the job, follow up with the job application, etc. Each action item may also be assigned a suggested deadline by which the user should complete the action item. Action items can also be generated based on the job readiness report. For example, if the user indicates that he/she does not have a resume prepared, an action item may be generated to prepare a resume, have the resume reviewed, etc.

In one embodiment, the user can interact with the action items. For example, the user can check off action items that are completed. In one embodiment, job readiness scores are dynamically updated 375 responsive to checking off an action item. For example, if a user checks off an action item for preparing a resume, then the job readiness evaluator 230 may automatically increase the readiness score to reflect this.

In one embodiment, the IJH engine 120 furthermore determined a probability of the user being qualified for and/or landing a particular job opening and presents the probability together with the sorted job openings. In this embodiment, the IJH engine 120 can use information from the user's job readiness scores and other information in the user's profile to model the user's chance. Additionally, the IJH engine 120 can use information accumulated about the particular job field, company, and location to determine the probability of the user being qualified for and/or landing a particular job opening.

FIG. 4 is a flowchart illustrating an example embodiment of a process for mapping 315 a job opening to a standardized job description from the job description index 140. Generally, the process compares a job opening to a set of job descriptions (i.e. the “comparison set”) from the job description index 140 and determines the standardized job description from the index 140 having the best match. Initially, the comparison set includes 410 the entire job description index 140 including both primary job titles and alternative job titles. Data fields are selected 420 for matching. In one embodiment the data field for matching is a “job title” field. In another embodiment, a “job description” field can be used for matching. In yet other embodiments, other fields can be used such as, for example, salary, experience level, job level, location, skills required, and so on. A matching score is generated 430 between a job opening from the job openings index 150 and each standardized job description in the comparison set. Any pattern matching or word matching algorithm can be used to generate the matching score. For example, in one embodiment a Boyer-Moore matching algorithm is applied to generate a matching score representative of the strength of the match between text of the job opening and text in the standardized job description for the chosen field. The job search engine 210 then determines 440 if further refinement is needed. Criteria for this decision may include, for example, a number of the standardized job descriptions that have a matching score above a predefined threshold, a percentage of job descriptions that have a matching score above a predefined threshold, a number of job descriptions that have a matching score below a predefined threshold, etc. If no further refinement is needed, then the job search engine 210 maps 450 the job opening to the entry in the standardized job description index 140 that has the highest matching score. If further refinement is needed, the comparison set is reduced 460 in size. For example, in one embodiment, the comparison set is reduced to include only job descriptions having matching scores above a particular threshold in the current iteration. In another embodiment, the comparison set can be reduced to include a fixed number of job descriptions that have the highest matching scores. The process then iterates 470. Different iterations of the process may select 420 different data fields for matching. For example, in one embodiment, the process first selects 420 the “title” field for matching against the full comparison set. Thus, in the first iteration, the matching scores represent a strength of the match between the job title in the job opening and one the standardized job titles (primary or alternative) in the standardized job description index 140. In the second iteration of the process, the “description” field is selected for matching against the reduced comparisons set. Thus, in the second iteration, the matching scores represent a strength of the match between the job description in the job opening and one the standardized job descriptions in the standardized job description index 140.

FIG. 5 is a flowchart illustrating an example embodiment of a process for sorting 320 jobs according to the different category filters 220. One or more preliminary filters are applied 510 to the pool of job openings to obtain a reduced set of job openings. The preliminary filters can be based on, for example, the job group, job level, salary, location, abilities required, etc. and may depend on the specific category filter being applied. For example, if the category filter is designed to help the user find jobs that match his/her current job field and skill level, the job group may be limited to that corresponding to the user's current job. Alternatively, if the category filter is designed to help the user branch out into a new field, the job group may be limited to those corresponding to jobs outside of the user's current job group. If the category filter is designed to help the user advance to a higher level position, the job level may be limited to job levels one or two levels higher than the user's current job level.

The user may also specify specific terms that should be excluded from the results. For example, the user may indicate in his/her profile that he/she is not interested in any jobs relating to “chemistry.” Such jobs would also be filtered out by the preliminary filters.

In one embodiment, the step of applying 510 the preliminary filters is implemented prior to the step of mapping 315 job openings to entries in the standardized job description index 140. By applying 510 the filters prior to mapping 315, only the job openings that pass through the filters are mapped 315. Thus, the embodiment offers improved computational efficiency because fewer mappings are determined.

For each of the job openings remaining in the pool after the preliminary filters are applied, one or more matching scores is determined 520. Each of the matching scores (e.g., 520-1, 520-2, etc.) indicates a relative strength of a match between a job opening and a target job criteria. The target job criteria comprise job criteria considered relevant to the user based on information in the user's profile. For example, the target job criteria can include criteria related to the user's current job, the job of a role model from the “UpModel” profiles index 160, a job the user has expressed interest in, a job the user has previously applied for, etc. The target job criteria selected for comparison can also vary depending on the type of category filter being applied. For example, if the category filter is designed to help the user find a job similar to his/her current job, the target job criteria may be based in part on the user's current job. If the category filter is designed to help the user follow the career of a role model, the target job criteria may be based in part on the role model's job. The target job criteria typically corresponds to information extracted from an entry in the standardized job index 140 and thus includes information in various fields (e.g., title, description, salary, etc.) in a standard format. Alternatively, target job criteria can includes information in user-defined terms. In this embodiment, the user may enter his exact job title, salary, responsibilities, location, etc. in a manner that do not necessarily conform to an entry in the standardized job index 140. For example, based on the standardized set of job descriptions in the job description index 140, the user's job may be mapped to the job title “Chemist I”, but the user's actual title may be “Wine Chemist.” Thus, the user-defined term, “Wine Chemist” could be used as one of many target criteria for generating the matching scores instead of, or in addition to, the standardized title “Chemist I.”

Each of the matching scores (e.g., 520-1, 520-2, etc.) can be based on target job criteria relating to two different jobs or relating to the same job. For example, in one embodiment, the target job criteria comprises a job title field relating to a particular target job. The matching score is determined by comparing a title field of the job opening to a title field of a target job using pattern or text matching algorithms such as, for example, a Boyer-Moore matching algorithm. Another matching score may be computed using a job description field as the target job criteria. In another embodiment, matching scores can be computed using a job location as the target job criteria. In this embodiment, the matching score is representative of the proximity of the location of the job opening to the location of the target job being compared (e.g, the user's current job, role model jobs, etc.). In one embodiment, a location score is normalized to same scale as the word matching or pattern matching scores so that the scores can be directly compared. In another embodiment, a matching score uses a job level as the target job criteria. In this embodiment, the matching score is representative of the closeness of a job level of the job opening and a target job level.

According to different category filters, any number of matching scores can be computed, each associated with a different target job criteria. Additionally, different target job criteria can be used depending on the particular goals of the category filters.

An overall score for each job listing is determined 530 by weighting and summing the matching scores. The weights of the matching scores depend on the particular category filter being applied. For example, in one category filter, 90% of the score may be based on the matching score of a job title of a job opening to the job title of the user's current job, and 10% of the score may be based on the matching score of the a job title of the job opening to a job title of the role model's job. The job opening are then sorted 540 according to their scores within the various categories.

Several examples of specific category filters are now described. An “On My Roadmap” category filter is designed to assist the user in finding jobs that are the next logical step in his/her career. For this category filter, preliminary filters limit the job openings pool to jobs that are within the job group of the user's current job, are one or two levels higher than the user's current job, and do not contain any user-excluded terms. Matching scores are computed using the user's current job and a role model's job as the target jobs using, for example, the title fields as the target job criteria. An overall score is computed for each job opening giving 90% weight to the matching score with the user's current job title, and a 10% weight to the matching score with the role model's job title for example.

An “In My Range” category filter is designed to assist the user in finding jobs that are within the user's current abilities. For this category filter, preliminary filters limit the job openings pool to jobs that are within the job group of the user's current job, are equal in job level or one level below the user's current job, and do not contain any user-excluded terms. Matching scores are computed using the user's current job and a role model's job as the target jobs using, for example, the title fields and job level fields as the target job criteria. An overall score is computed for each job opening giving 60% weight to the matching score with the user's current job title, 30% weight to a matching score to the user's current job level, and a 10% weight to the matching score with a role model's job title for example.

An “Expand My Horizons” category filter is designed to assist the user in finding jobs outside his/her current field. For this category filter, preliminary filters limit the job openings pool to jobs that are outside of the job group of the user's current job, are equal in job level or one level below the user's current job level, and do not contain any user-excluded terms. Matching scores are computed using the user's current job title, user-specified jobs titles, and a role model's job title as the target job criteria. An overall score is computed for each job opening giving 25% weight to the matching score with the user's current job title, 50% weight to a matching score with user-defined job titles of interest, and a 25% weight to the matching score with a role model's job title for example.

A “Boost My Ego” category filter is designed to assist the user in finding jobs that are a step up from his/her current job. For this category filter, preliminary filters limit the job openings pool to jobs that are within the job group of the user's current job, are three or more levels higher than the user's current job level, and do not contain any user-excluded terms. Matching scores are computed using the user's current job title and a role model's job title as the target job criteria. An overall score is computed for each job opening giving 70% weight to the matching score with the user's current job title, and 30% weight to the matching score with a role model's job title for example.

A “Match My UpModel” category filter is designed to assist the user in finding jobs that are similar to those held by a role model. For this category filter, preliminary filters limit the job openings pool to jobs within the role model's job group and do not contain any user-excluded terms. Matching scores are computed using the user's current job level and user-specified job titles of interest as target job criteria. An overall score is computed for each job opening giving 80% weight to the matching score with the user's current job level, and 20% weight to a matching score with user-defined job titles of interest for example.

A “Near My Home” category filter is designed to assist the user in finding jobs that are near his/her current home. For this category filter, preliminary filters limit the job openings pool to jobs that are within the job group of the user's current job, are equal in job level or one or two levels above the user's current job level, and do not contain any user-excluded terms. Matching scores are computed using the user's current job title and home geographic location as target job criteria. An overall score is computed for each job opening giving 70% weight to the matching score with the user's current home geographic location and 30% weight to a matching score with the user's current job title for example.

A “Connected to My Network” category filter is designed to assist the user in finding jobs related to those held by other individuals in his/her network. For this category filter, preliminary filters limit the job openings pool to jobs that are at a company of an individual in the user's network. Matching scores are computed using the user's current job title as the target job criteria. An overall score is computed for each job opening giving 100% weight to the matching score with the user's current job title for example.

Those of ordinary skill in the art will recognize that other category filters can be applied to present a different sorting of the job openings according to varying objectives.

FIG. 6 is a flowchart illustrates an embodiment of a process for analyzing 325 user interactions and applying dynamic updates 330. User interactions are collected 610 in order to gather useful information about the user. As mentioned above, the collected interactions can include user interactions with the set of job openings selected for the user such as, for example, viewing a particular job opening, marking a job opening, saving a job opening, deleting a job opening, etc. In one embodiment, the IJH engine 120 can also analyze user interactions from other sources. For example, the IJH engine 120 can analyze information from other web-based services such as social networking services (e.g., facebook.com, linkedin.com, etc.), blogging services (e.g., twitter.com), etc. The IJH engine 120 can also analyze information pertaining to the user's interpersonal skills or job skills such as, for example, the user's experience with a specific computer language or the user's ability to speak in public. Furthermore, the IJH engine 120 can analyze information related to the user's personality through assessment tools such as Myers-Briggs or the Personality Plus profile. Other information already included in the user's profile can also be analyzed for this purpose.

The dynamic update engine 250 then determines 620 an updated selection of job groups (step 305 in FIG. 3) and determines 630 an updated sorting of job openings in each of the category filters (step 325 in FIG. 3). A dynamic update 330 is applied to reflect these changes. For example, in one embodiment, user actions such as marking a job opening or viewing a job opening increase the overall matching score for the job opening in the sorted lists. Conversely, actions such as deleting a job, decreases the overall matching score for the job opening in the sorted list, or eliminates the job opening from the sorted list entirely.

In another embodiment, the selected job groups for searching the sorted list are dynamically updated 330 whenever the user adds additional relevant information to his/her profile. For example, a user may add information to refine or expand job searches by entering particular job titles, companies, job groups, etc. that the user is interested in. The additional information can be used to update the selected job groups and to increase matching scores in the sorted lists for job openings that match the user-specified terms. Conversely, the user may enter information to exclude particular companies, job titles, job groups, etc. from the search results. Such exclusions may result in removing relevant job groups from future searches. Furthermore, job openings relevant to the excluded terms can have their matching scores decreased in the sorted lists or eliminated entirely. In yet another embodiment, updates to the job groups and sorted lists are applied when jobs of other individuals within the user's network change positions, companies, etc. Such information could reflect changes to networked user profiles within IJH system 100 or can reflect changes on external social networks.

Beneficially, the IJH system 100 finds and presents a set of job openings that are specific to the user's career goals, interests, and abilities. Thus, the IJH system 100 allows the user to easily determine the jobs he/she is most interested in and simplifies the user's job hunting process.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the media host service may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. All such process steps, instructions or algorithms are executed by computing devices that include some form of processing unit (e.g,. a microprocessor, microcontroller, dedicated logic circuit or the like) as well as a memory (RAM, ROM, or the like), and input/output devices as appropriate for receiving or providing data.

The present invention also relates to an apparatus for performing the operations herein. This apparatus may be specially constructed for the required purposes, or it may comprise a general-purpose computer selectively activated or reconfigured by a computer program stored in the computer, in which event the general-purpose computer is structurally and functionally equivalent to a specific computer dedicated to performing the functions and operations described herein. A computer program that embodies computer executable data (e.g. program code and data) is stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for persistently storing electronically coded instructions. It should be further noted that such computer programs by nature of their existence as data stored in a physical medium by alterations of such medium, such as alterations or variations in the physical structure and/or properties (e.g., electrical, optical, mechanical, magnetic, chemical properties) of the medium, are not abstract ideas or concepts or representations per se, but instead are physical artifacts produced by physical processes that transform a physical medium from one state to another state (e.g., a change in the electrical charge, or a change in magnetic polarity) in order to persistently store the computer program in the medium. Furthermore, the computers referred to in the specification may include a single processor or may be architectures employing multiple processor designs for increased computing capability.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A computer-implemented method for sorting a set of job openings according to their relevance to a user, the method comprising:
receiving profile information related to a user's career;
determining target job criteria related to the user's career based on the profile information, the target job criteria including a first target job criteria and as second target job criteria;
determining a set of current job openings;
determining a first matching score between a job opening from the set of current job openings and the first target job criteria;
determining a second matching score between the job opening and the second target job criteria;
weighting and combining the first and second matching scores to generate an overall score for the job opening;
sorting the set of job openings according to their overall scores; and
outputting the sorted set of job openings.

2. The method of claim 1, wherein determining a set of current job openings comprises:
determining an initial set of job groups for searching, wherein each job group of the initial set represents a set of related job including a job relevant to the profile information;
querying a job openings index using the initial set of job groups to retrieve the set of current job openings; and
mapping each job opening from the set of current job openings to a job description from a standardized job description index.

3. The method of claim 2, wherein mapping each job opening comprises:
selecting a job opening for matching;
generating a first matching score between a first field of the job opening and a first field of each job description in a comparison set from the standardized job description index; and
mapping the job opening to the job description in the comparison set having a highest matching score.

4. The method of claim 3, further comprising:
reducing the comparison set to include fewer job descriptions; and
generating a second matching score between a second field of the job opening and a second field of each increasingly specific job description in the reduced comparison set.

5. The method of claim 1, wherein determining the set of current job openings further comprises:
applying a preliminary filter to the current set of job openings to eliminate one or more of the current set of job openings.

6. The method of claim 1, wherein determining the first matching score comprises:
applying a pattern matching algorithm to the job opening and the first target job criteria; and
outputting the matching score indicative of a relative strength of a match between a field of the job opening and the first target job criteria.

7. The method of claim 1, further comprising:
presenting a series of job readiness questions to the user;
determining a job readiness score based on answers to the job readiness questions; and
generating a job readiness report based on the answers.

8. The method of claim 1, further comprising:
generating an action item based on at least one of the sorted set of job openings and the profile information known about the user.

9. The method of claim 1, further comprising:
dynamically updating the filtering and sorting of the job openings based on user interactions within the system, including the sorted set of job openings and behavior and responses within the system.

10. A computer readable storage medium for sorting a set of job openings according to their relevance to a user, the computer readable storage medium storing computer-executable program code that when executed cause a processor to perform steps including:
receiving profile information related to the user's career;
determining target job criteria related to the user's career based on the profile information, the target job criteria including a first target job criteria and a second target job criteria;
determining a set of current job openings;
determining a first matching score between a job opening from the set of current job openings and the first target job criteria;
determining a second matching score between the job opening and the second target job criteria;
weighting and combining the first and second matching scores to generate an overall score for the job opening;
sorting the set of job openings according to their overall scores; and
outputting the sorted set of job openings.

11. The computer readable storage medium of claim 10, wherein determining a set of current job openings comprises:
determining an initial set of job groups for searching, wherein each job group of the initial set represents a set of related job including a job relevant to the profile information;
querying a job openings index using the initial set of job groups to retrieve the set of current job openings; and
mapping each job opening from the set of current job openings to a job description from a standardized job description index.

12. The computer readable storage medium of claim 11, wherein mapping each job opening comprises:
selecting a job opening for matching;
generating a first matching score between a first field of the job opening and a first field of each job description in a comparison set from the standardized job description index; and
mapping the job opening to the job description in the comparison set having a highest matching score.

13. The computer readable storage medium of claim 12, further comprising:
reducing the comparison set to include fewer job descriptions; and
generating a second matching score between a second field of the job opening and a second field of each job description in the reduced comparison set.

14. The computer readable storage medium of claim 10, wherein determining the first matching score comprises:
applying a pattern matching algorithm to the job opening and the first target job; and
outputting the matching score indicative of a relative strength of a match between a field of the job opening and a field of the first target job criteria.

15. The computer readable storage medium of claim 10, further comprising:
presenting a series of job readiness questions to the user;
determining a job readiness score based on answers to the job readiness questions; and
generating a job readiness report based on the answers.

16. The computer readable storage medium of claim 10, further comprising:
generating an action item based on at least one of the sorted set of job openings and the profile information known about the user.

17. The computer readable storage medium of claim 10, further comprising:
dynamically updating the filtering and sorting of the job openings based on user interactions with the sorted set of job openings.

18. A computer-implemented method for providing one or more probable job matches to a user, the method comprising:
collecting, by an expert system, a plurality of information about the user;
collecting, by the expert system, a plurality of job openings for matching with the user; and
determining, by the expert system, at least one job opening from the plurality of job openings that are highly probable job matches for the user based on the plurality of collected information about the user.

19. The method of claim 18, wherein the plurality of collected information about the user comprises at least one of employment history, skills, geographic location, people the user knows, activities the user participates in, short-term desires, long-term desires, and impressions of others about the user.

20. The method of claim 18, wherein collecting information about the user comprises at least one of collecting the information directly from the user, collecting the information from a peer group of the user, collecting the information from the user's behavior within the expert system, collecting the information from web sources outside of the expert system, and collecting information from profiles on other web sites external from the expert system.
